(19) United States
(12) Patent Application Publication
(10) Pub. No.: US 2005/0256938 A1
(43) Pub. Date: Nov. 17, 2005

(54) Distributed computing system

(76) Inventor: Jed Margolin, San Jose, CA (US)

Correspondence Address: JED MARGOLIN, 3570 PLEASANT ECHO DRIVE, SAN JOSE, CA, 951481916, US

(21) Appl. No.: 09/947,801

(22) Filed: Sep. 6, 2001

Related U.S. Application Data
(60) Provisional application No. 60/249,830, filed on Nov. 17, 2000.

(51) Int. Cl. G06F 15/16

(52) U.S. Cl. 709/218

(57) ABSTRACT

A distributed computing system uses the computing resources of Home Network Servers connected through the Internet, where the owners of the Home Network Servers receive something of value in return for access to their Home Network Server's otherwise unused computing resources. The contracting company may use these distributed computing resources itself or it may resell the resources to others.

### CROSS REFERENCES TO RELATED APPLICATIONS

This application claims the benefit of U.S. Provisional Application No. 60/249,830 filed on Nov. 17, 2000.

### BACKGROUND OF THE INVENTION

1. Field of Invention

This invention relates to a distributed computing system. For the purposes of this application the term “distributed computing” includes “distributed storage.” The term “Internet” refers to the current world wide packet data communication network and whatever system may replace it regardless of what name it may be given or what communications protocol it may use. It also includes on-line services which, although they may not consider themselves the “Internet”, provide a gateway for their subscribers to the Internet.

2. Prior Art

An article in the November 2000 issue of Scientific American (Wholesale Computation by Paul Wallich) describes the distributed computing model used by SETI@home whereby PC owners volunteer the spare computing resources of their PCs connected to the Internet. The article also describes several commercial companies working on similar distributed computing systems but where the PC owners are paid for access to their PCs.

Another article in the November 2000 issue of Scientific American (As We May Live by W. Wayt Gibbs) describes the home of the future where the home's major systems (as well as a variety of sensors) are networked together and to the Internet.

There are a number of Internet Service Providers (ISPs) who offer a free Internet connection to users. However, in general, the users give up a great deal of privacy, the users give up a portion of the monitor display area for advertisements, and service is poor.

U.S. Pat. No. 6,112,225 TASK DISTRIBUTION PROCESSING SYSTEM AND THE METHOD FOR SUBSCRIBING COMPUTERS TO PERFORM COMPUTING TASKS DURING IDLE TIME issued Aug. 29, 2000 to Kraft, et al. describes a method for a distributed computing system that uses a computer's resources during times that the computer would otherwise be unused.

### BACKGROUND OF THE INVENTION

The article in the November 2000 issue of Scientific American (Wholesale Computation by Paul Wallich) describes the distributed computing system used by SETI@home whereby PC owners volunteer the spare computing resources of their PCs connected to the Internet. The article also describes several commercial companies working on similar distributed computing systems but where the PC owners are paid for access to their machines. There are several problems such as concerns about the security of the data on which the distributed computing is being performed, as well as users' concerns about the security of their own data as well as the need to protect the users' computers from potentially malicious code.

The other article in the November 2000 issue of Scientific American (As We May Live by W. Wayt Gibbs) describes the home of the future where the home's major systems (as well as a variety of sensors) are networked together and to the Internet. Even at the present time, more and more homes are networking their existing computers together.

Typically, in subscribing to one of the number of Internet Service Providers (ISPs) who offer a free Internet connection to users, generally the users give up a great deal of privacy (the user's movements on the Internet are tracked), the users give up a portion of the monitor display area for advertisements (as well as the bandwidth for downloading the ads), and service is poor.

With the present systems used for distributed computing, where the distributed programming runs on a user's computers, the distributed programming must run under the user's operating system. Unfortunately, most operating systems used on home PCs are less than robust. Upgrading to a more robust operating system frequently means purchasing new software because the old software will not run properly on the new operating system. New versions of the old software might not even be available.

Upgrading to a more robust operating system may also require purchasing new peripherals because the software drivers needed for peripherals such as scanners and modems may not be available for the new operating system. A further problem is that adding additional applications to a user's computer frequently causes existing applications to stop working. Thus, even after a computer used in an existing distributed computing system is working properly, a user adding an additional, unrelated application, may cause the system to crash, or even worse, become unreliable. Or, it may simply be really annoying, such as when the Operating System refuses to shut down after being expressly ordered to do so.

Accordingly, one of the objects and advantages of the present invention is to provide a new method of providing a distributed computing system where the subscriber receives something of value in return for access to the otherwise unused computing resources on their Home Network Server running a robust operating system, in a way that preserves the subscriber's privacy, data security, and investment in hardware and software.

Further objects and advantages of my invention will become apparent from a consideration of the drawings and ensuing description.

### SUMMARY OF THE INVENTION

A Home Network Server is used in a home to network various clients such as PCs, sensors, actuators, and other devices. It also provides the Internet connection to the various client devices in the Home Network. The Home Network Server also provides a firewall to prevent unauthorized access to the Home Network from the Internet. The use of a Home Network Server, as opposed to the use of peer-to-peer networking, allows a robust operating system to be used. It also allows the users on the Home Network to add additional applications to their PCs without fear of jeopardizing the proper functioning of their Internet security program (firewall) or the distributed computing software. (Although a firewall is not strictly necessary, prudence dictates its use.)

The otherwise unused capacity of the Home Network Server is used for distributed computing which is controlled by a contracting company through the Internet.

In exchange for the use of the otherwise unused capacity of the Home Network Server for distributed computing, the contracting company provides the subscriber (nominally the owner of the Home Network) something of value such as reduced cost of Internet service, free Internet service, or a net payment. The contracting company may alternatively or additionally subsidize the purchase costs of the Home Network Server or other equipment.

Since Home Network Servers may be located in widely different geographic areas, the use of Home Network Servers for distributed computing also distributes the load on electric utility companies.

In addition, as CPUs become faster and storage devices such as hard drives and optical storage devices become larger, and fast Internet connections become more widespread, the distributed computing system can also be used as a distributed server system, making large server farms (with their attendant demands on electric utilities) unnecessary.

### DESCRIPTION OF THE DRAWINGS

FIG. 1 shows a configuration of a home network server.

FIG. 2 shows a configuration of the invention with a firewall between the Internet connection and the Home Network as well as a firewall between the Internet connection and the Distributed Computing application.

FIG. 3 shows an alternate configuration of the invention with a firewall between the Internet connection and the Home Network as well as a firewall between the Home Network and the Distributed Computing application.

### DETAILED DESCRIPTION

In the following description, numerous specific details are set forth to provide a thorough understanding of the invention. However, it is understood that the invention may be practiced without these specific details. In other instances, well-known circuits, structures and techniques have not been shown in detail in order not to obscure the invention.

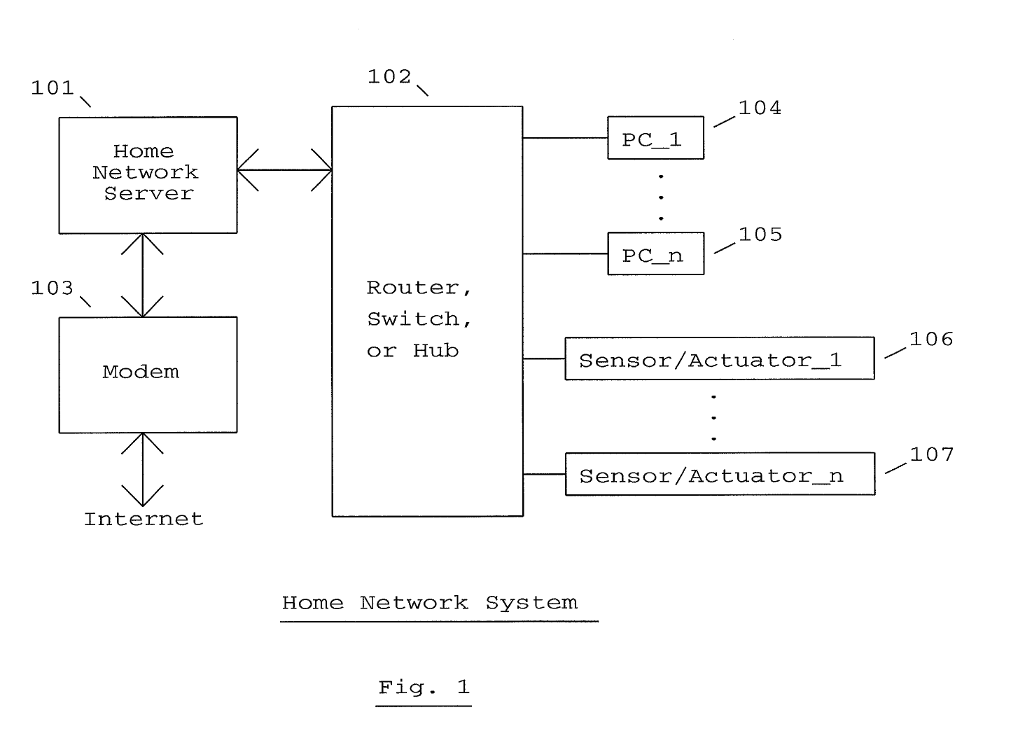

The general form of the Home Network System is shown in FIG. 1. Home Network Server 101 is of conventional design and includes a CPU, memory, mass storage (typically a hard disk drive for operations and a CD-ROM or DVD-ROM Drive for software installation), video display capabilities, and a keyboard. Because video from Home Network Server 101 is used mostly for system installation and monitoring, a standard low-cost video system and monitor may be used. A recordable/rewritable version of the CD-ROM or DVD-ROM drive may be used to provide system and network backup capabilities. An alternative form of system and network backup such as one using magnetic tape may also be used. In addition, Home Network Server 101 may provide sound capabilities for the purpose of providing audible warnings and alarms.

Home Network Server 101 uses Modem 103 to connect to the Internet. Preferably, Modem 103 provides an always-on connection using DSL, a cable modem, or equivalent. However, as an alternative, Modem 103 may provide a dial-up connection to the Internet.

Home Network Server 101 connects to Router, Switch, or Hub 102. Although a Router is preferable, a Switch or a Hub may also be used.

Router, Switch, or Hub 102 connects to one or more clients such as PC_1 104 or Sensor/Actuator_1 106. More than one client PC may be used, such as PC_n 105, and more than one Sensor/Actuator may be used, such as Sensor/Actuator_n 107. Sensor/Actuators are used to control and/or monitor the home's systems such as HVAC and Security and appliances such as refrigerators, washers, and dryers.

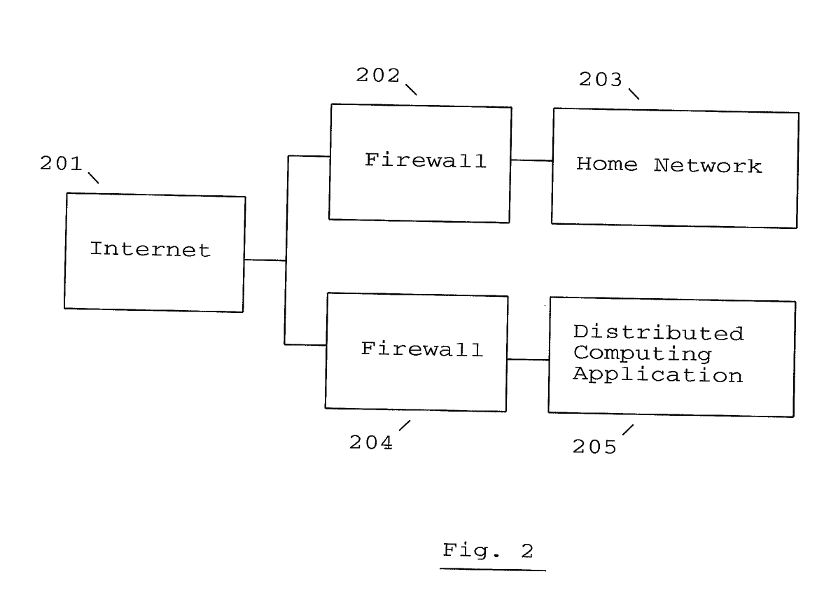

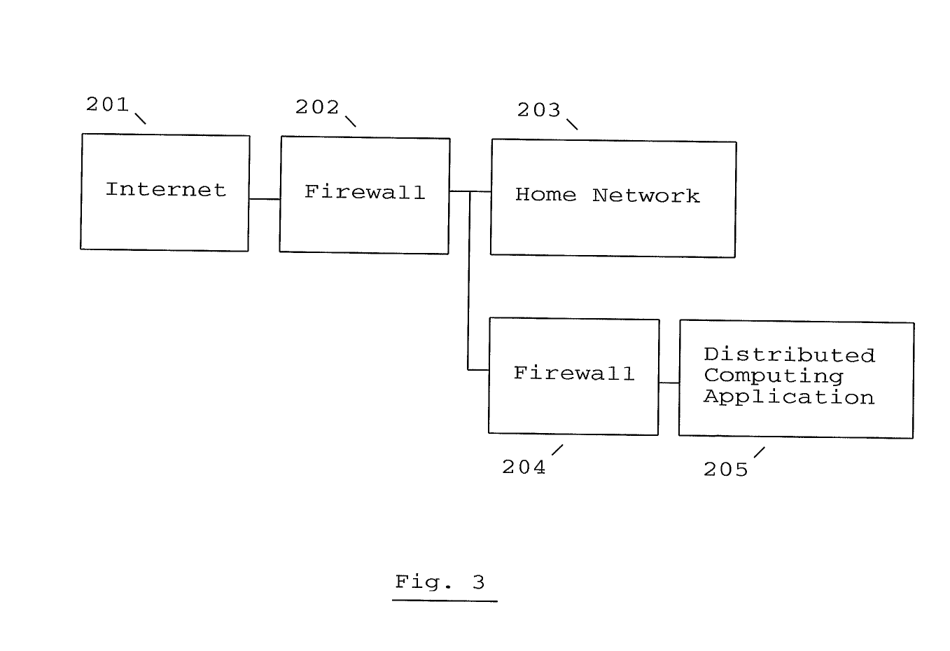

As shown in FIG. 2, software Firewall 202 protects Home Network 203 from unwanted intrusions coming from Internet 201. Firewall 204 protects Distributed Computing Application 205 from unwanted intrusions coming from Internet 201. Firewall 204 also protects against unwanted interactions between Home Network 203 and Distributed Computing Application 205. An alternative arrangement to perform the same functions is shown in FIG. 3.

For reliability, Home Network Server 101 may use a robust operating system that can run for long periods of time without crashing. Additional reliability may be obtained through the use of an Uninterruptible Power Supply (UPS), preferably one that performs power conditioning.

The otherwise unused capacity of Home Network Server 101 is used for distributed computing which is controlled by a contracting company through the Internet. The contracting company may use the distributed computing resources itself or it may resell the resources to others.

In exchange for the use of the otherwise unused capacity of Home Network Server 101 for distributed computing, the contracting company provides the subscriber with something of value such as reduced cost of Internet service, free Internet service, or a net payment. The contracting company may alternatively or additionally subsidize the purchase costs of the Home Network Server or other equipment.

While preferred embodiments of the present invention have been shown, it is to be expressly understood that modifications and changes may be made thereto.

1. A distributed computing system comprising:
(a) a home network server in a subscriber's home;
(b) one or more home network client devices;
(c) an Internet connection;
whereby the subscriber receives something of value in return for access to the resources of said home network server that would otherwise be unused.

2. The distributed computing system of claim 1 further comprising:
(a) a first firewall between said Internet connection and said home network server;
(b) a second firewall to prevent unwanted interactions between said access to the resources of said home network server that would otherwise be unused and said home network server.

3. A method for providing a distributed computing system comprising the steps of:
(a) providing a home network server in a subscriber's home;
(b) providing one or more home network client devices;
(c) providing an Internet connection;
whereby the subscriber receives something of value in return for access to the resources of said home network server that would otherwise be unused.

4. The method of claim 3 further comprising the steps of:
(a) providing a first firewall between said Internet connection and said home network server;
(b) providing a second firewall to prevent unwanted interactions between said access to the resources of said home network server that would otherwise be unused and said home network server.

5. A method for providing a distributed computing system comprising the steps of:
(a) providing a home network server in a subscriber's home;
(b) providing one or more home network client devices;
(c) providing an Internet connection;
(d) providing access to the resources of said home network server that would otherwise be unused;
(e) providing a first firewall between said Internet connection and said home network server;
(f) providing a second firewall to prevent unwanted interactions between said access to the resources of said home network that would otherwise be unused and said home network server;
whereby the subscriber receives something of value in return for said access to the resources of said home network server that would otherwise be unused.
